(19) United States
(12) Patent Application Publication
(10) Pub. No.: US 2015/0082149 A1
(43) Pub. Date: Mar. 19, 2015

(54) Hierarchical Image Management for Web Content

(71) Applicant: Adobe Systems Incorporated, San Jose, CA (US)

(72) Inventors: Artur W. Kudlacz, Allschwil (CH); Damien M. Antipa, Saint-Louis (FR)

(73) Assignee: Adobe Systems Incorporated, San Jose, CA (US)

(21) Appl. No.: 14/027,855

(22) Filed: Sep. 16, 2013

(51) Int. Cl. G06F 17/22

(52) U.S. Cl. CPC G06F 17/2247
USPC 715/236

(57) ABSTRACT

Hierarchical image management techniques for web content are described. In one or more implementations, a request is received for web content and a hierarchical structure is examined to determine which images correspond to the request for the web content. A communication is formed for communication of the web content that includes a file having a plurality of the images as a result of the examination and a stylesheet usable to locate individual ones of the plurality of images within the file to generate the requested web content.

### BACKGROUND

There is an ever increasing amount of web content made available via the Internet for consumption by a browser, a web-enabled application, and so on. In some instances, this web content may include a multitude of images that are to be fetched for consumption as part of the web content.

Using conventional techniques, consumption of such web content was performed through a series of requests to individually collect the images, even if included as part of a single webpage. Consequently, webpages having a large number of images also involved a large number of requests to obtain the images. This could make interaction with the webpages both inefficient and frustrating to users that are to view the webpage or other web content.

### SUMMARY

Hierarchical image management techniques for web content are described. In one or more implementations, a request is received for web content and a hierarchical structure is examined to determine which images correspond to the request for the web content. A communication is formed for communication of the web content that includes a file having a plurality of the images as a result of the examination and a stylesheet usable to locate individual ones of the plurality of images within the file to generate the requested web content.

In one or more implementations, a hierarchical structure of images is monitored for inclusion in web content. The hierarchical structure has a plurality of nodes that include files having one or more images and corresponding style sheets describing how to locate the one or more images in the files. A change is detected in at least one of the images included in a respective one of the nodes responsive to the monitoring. One or more files and corresponding style sheets are regenerated that include the changed at least one of the images.

In one or more implementations, a system includes at least one module and one or more modules implemented at least partially in hardware. The at least one module is configured to manage a hierarchical structure of images for inclusion in web content. The hierarchical structure has a plurality of nodes that include files having one or more images and corresponding style sheets describing how to locate the one or more images in the files. Responsive to receipt of an event indicating a change to one or more of the images, one or more files and corresponding style sheets are regenerated, by the at least one module, that include the changed one or more images. The one or more modules are configured to form a communication in response to a request for web content that includes a single file having a plurality of the images and a stylesheet usable to locate individual ones of the plurality of images within the file to generate the requested web content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ hierarchical image management techniques described herein.

FIG. 2 depicts a system showing the environment of FIG. 1 in greater detail as responding to a web content request through use of a hierarchy.

FIG. 3 is a flow diagram depicting a procedure in an example implementation in which a hierarchical structure is examined and used to fill a request for web content.

FIG. 4 depicts a system in an example implementation in which one or more techniques are performed to identify an image file and stylesheet that corresponds to a web content request.

FIG. 5 depicts an example of a hierarchy of nodes that include files and style sheets usable to locate images in the files.

FIG. 6 is a flow diagram depicting a procedure in an example implementation in which a hierarchy is managed, which includes regeneration of files responsive to a change in one or more images.

FIG. 7 depicts an example of a hierarchy of nodes that include files and style sheets including a change to one of the images which causes regeneration of a plurality of files and corresponding style sheets.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

Conventional techniques that are utilized to communicate images as part of web content (e.g., webpages and so on) typically involved a single request for each image. Therefore, even a single webpage that included multiple images could involve numerous requests to obtain the images. This problem may be further complicated by hard limits to parallel operations to a specific domain name and so forth.

Hierarchical image management techniques for web content are described. In one or more implementations, images such as raster graphics that do not change dynamically are combined into a single file, which may be used to significantly reduce a number of requests made to obtain the images by using a stylesheet to locate individual images in the file.

These files may be maintained within a hierarchical structure, such as a content repository having a plurality of nodes that reflect this hierarchical structure. Therefore, a request may be filled by locating which parts of the hierarchical structure correspond to the request. Further, the hierarchical structure may be managed such that changes to nodes may be detected, which may prompt regeneration of files of the node as well as any parent nodes. In this way, the files may be cached and maintained in a structure in an efficient manner that may also be leveraged to support communication of web content. Further discussion of these techniques may be found in relation to the following sections.

In the following discussion, an example environment is first described that may employ the techniques described herein. An implementation example and example procedures are then described which may be performed in the example environment as well as other environments. Consequently, performance of the example procedures is not limited to the example environment and the example environment is not limited to performance of the example procedures.

Example Environment

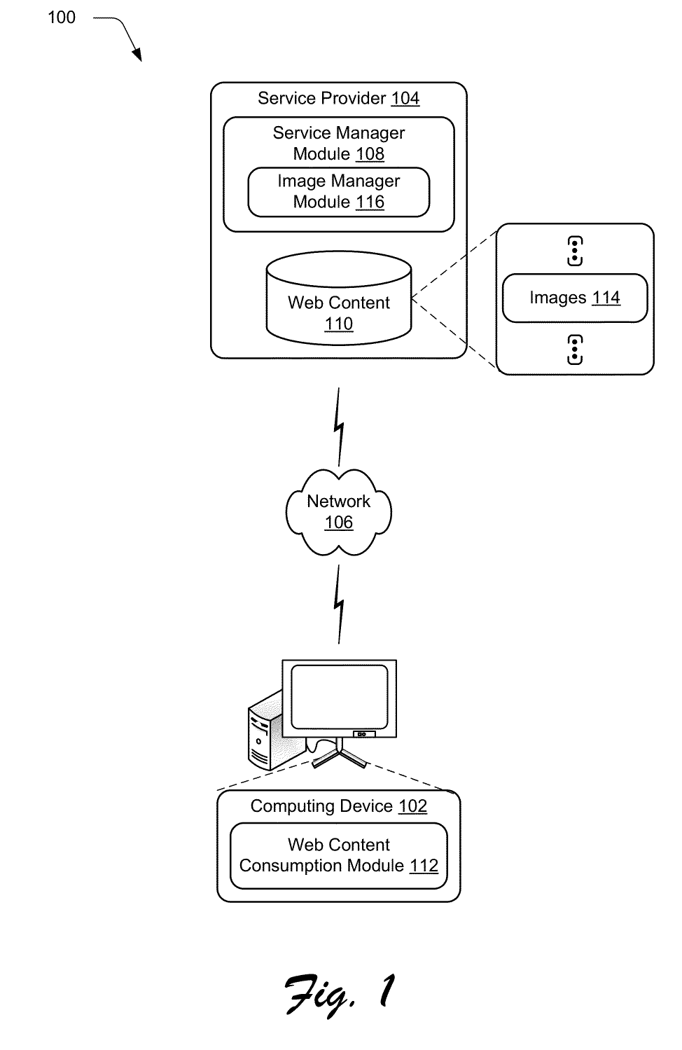

FIG. 1 is an illustration of an environment 100 in an example implementation that is operable to employ techniques described herein. The illustrated environment 100 includes a computing device 102 and a service provider 104 that are communicative coupled via a network 106. The computing device 102 as well as the computing devices that implement the service provider 104 may be configured in a variety of ways.

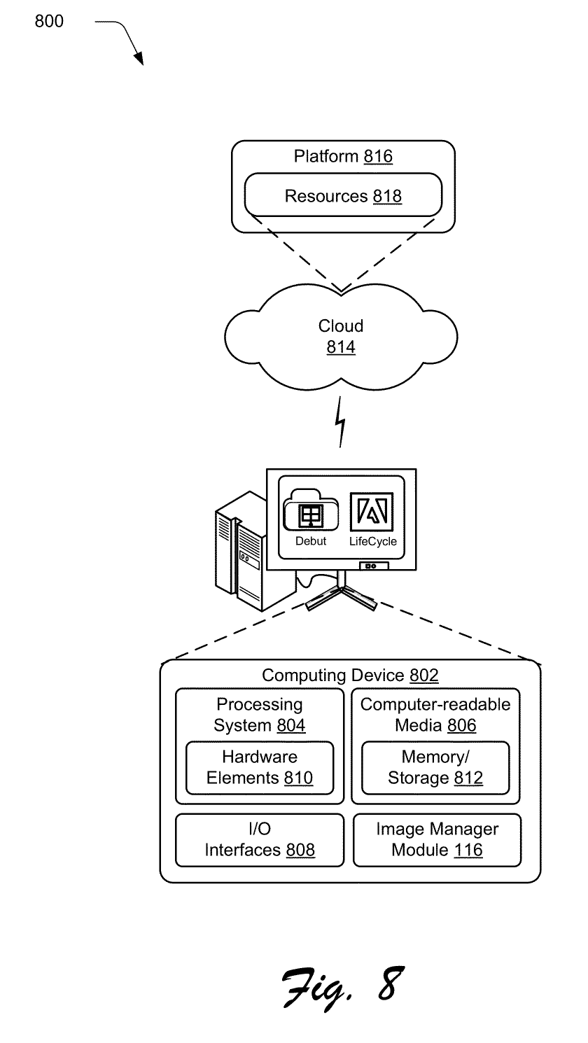

A computing device, for instance, may be configured as a desktop computer, a laptop computer, a mobile device (e.g., assuming a handheld configuration such as a tablet or mobile phone), and so forth. Thus, computing devices may range from full resource devices with substantial memory and processor resources (e.g., personal computers, game consoles) to a low-resource device with limited memory and/or processing resources (e.g., mobile devices). Additionally, although a single computing device may be described in the following, reference to a computing device may be representative of a plurality of different devices, such as multiple servers utilized by a business (e.g., the service provider 104) to perform operations “over the cloud” as further described in relation to FIG. 8.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may also be configured to include multiple networks.

The service provider 104 is illustrated as including a service manager module 108. The service manager module 108 is representative of functionality of the service provider 104 to manage web content 110 as part of one or more network-based services that is configured for consumption by a web content consumption module 112 of the computing device, e.g., a browser, web application, and so on. As such, the web content 110 may be configured in a variety of ways, such as one or more webpages of a website, configured for access as part of a network-based application (e.g., as part of a runtime of the application), and so on.

Individual items of the web content 110 may include one or more images 114, respectively. For example, web content 110 configured as a webpage, configured for consumption by a web application, and so forth may include a multitude of images 114 that are designed to provide a rich user experience to a user that obtained the web content 110 via the network 106, such as a user of the computing device 102.

Accordingly, the service manager module 108 in this instance is illustrated as including an image manager module 116. The image manager module 116 is representative of functionality to manage the images 114 for distribution as part of the web content 110. This may include packaging of the images 114 for consumption by a computing device 102, management of the images 114 in a database, and so on. An example of such management that include hierarchical techniques is described as follows and shown in a corresponding figure.

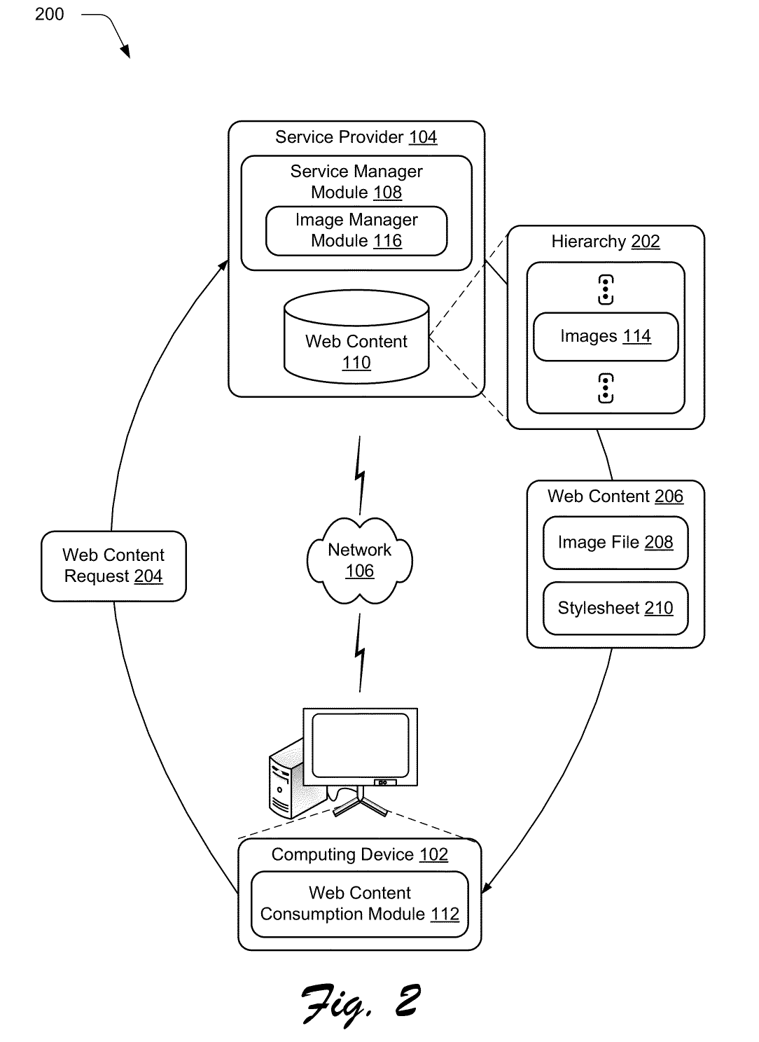

FIG. 2 depicts a system 200 in an example implementation in which the image manager module 116 of FIG. 1 manages the images 114 of FIG. 1 through use of a hierarchy 202. In this example, the web content consumption module 112 forms and communicates a web content request 204 via the network 106 for communication to the service provider 104.

In response, the image manager module 116 may locate images 114 that are included in the hierarchy 202. These images may be managed in a variety of ways. For example, the web content 110 may include raster graphics that do not change dynamically. As previously described, inclusion of multiple images at multiple occasions as part of the web content 220 may consume significant portions of the available resources of the service provider 104, network 106, and computing device 102 to communicate the images using conventional techniques.

Accordingly, the image manager module 116 may be configured to form an image file 208 that includes a plurality of images 114 included in the web content 206. This may be performed in a variety of ways, such as through configuration of the images 114 as sprites that are identifiable in the image file 208 using a stylesheet 210, e.g., in accordance with a cascading stylesheet (CSS). Other techniques may also be employed to locate individual images 114 from a plurality of images included in a single image file 208. In this way, a single file may be distributed that includes the images, which may increase efficiency by decreasing an amount of time to locate and communicate the images.

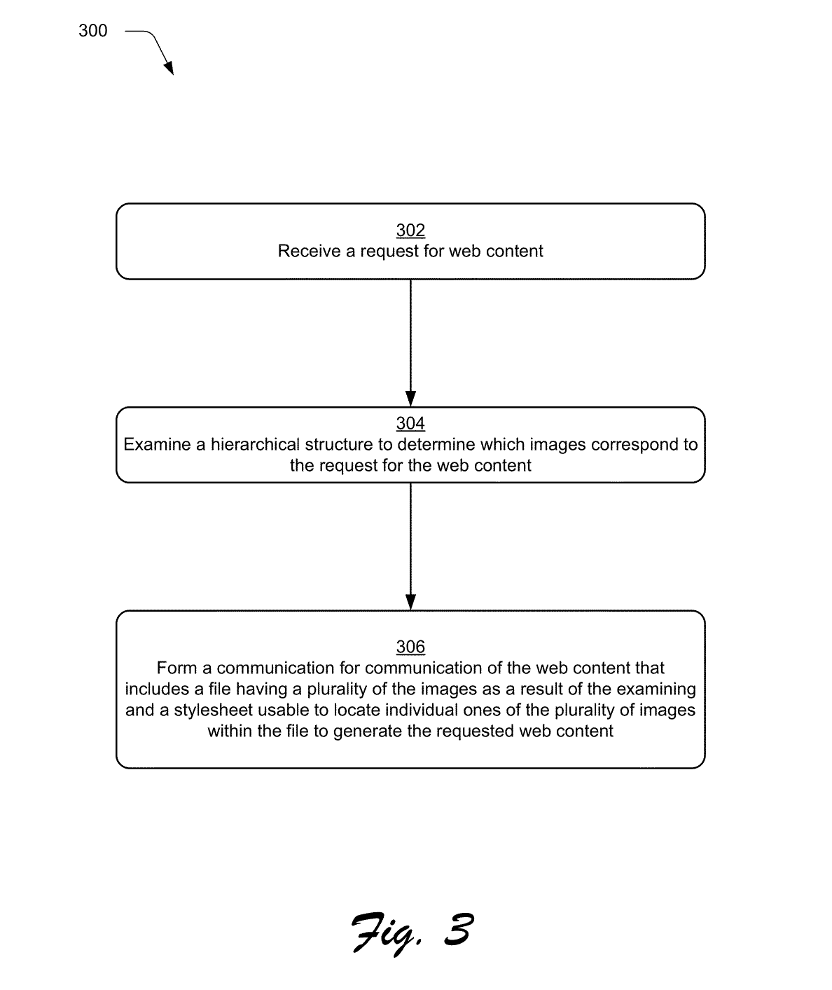

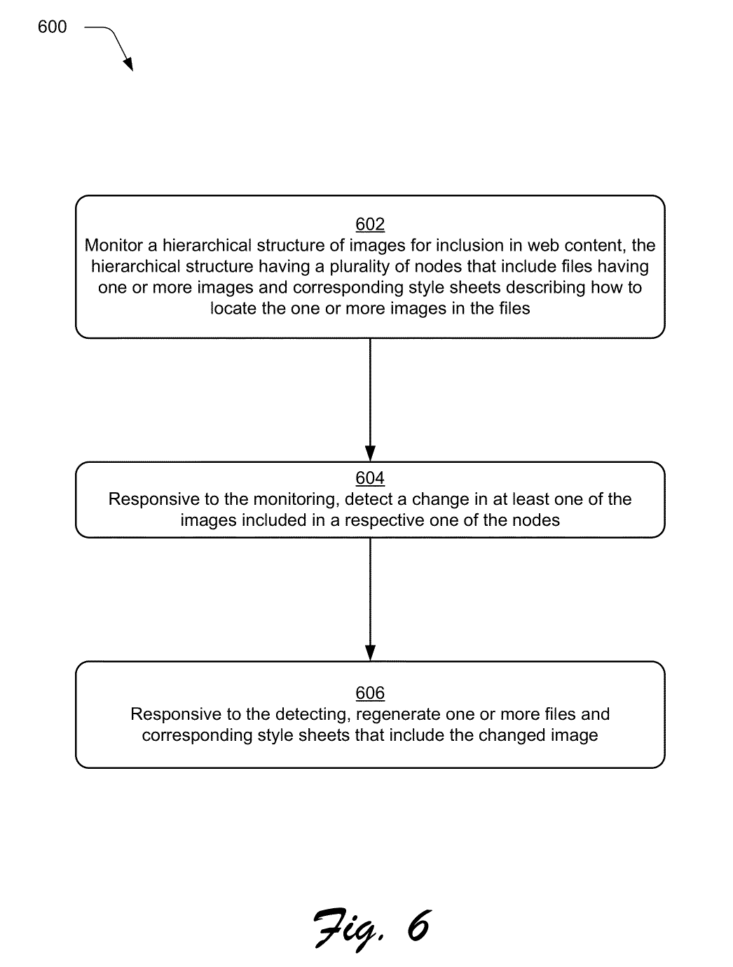

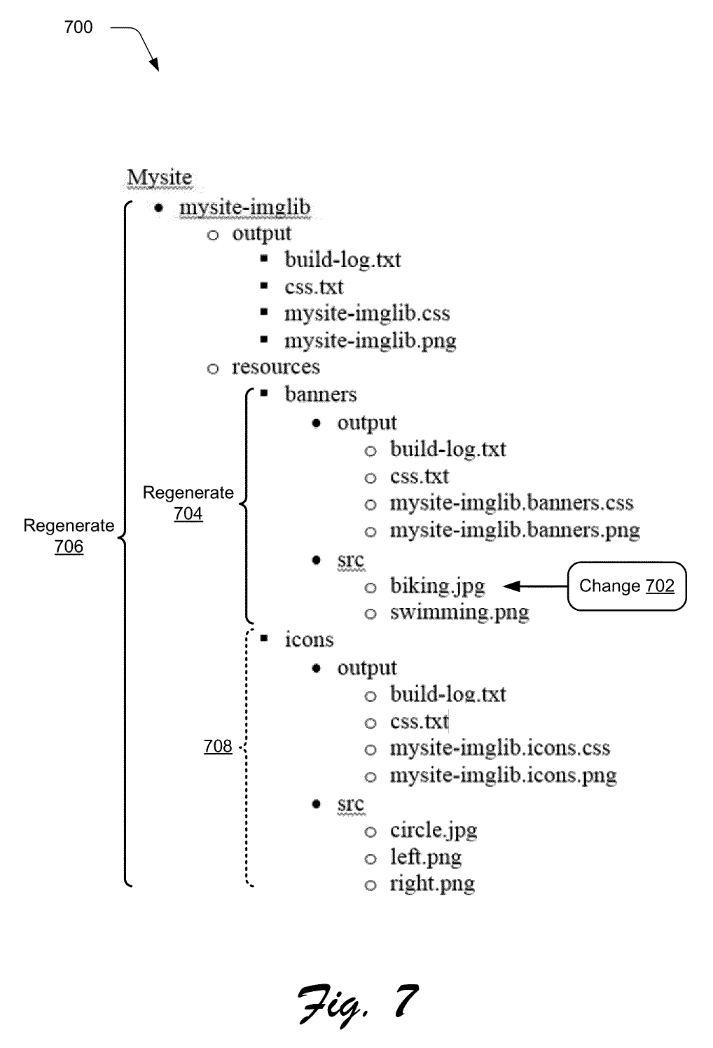

These image files 208 and style sheets 210 may then be maintained (e.g., cached) as part of a hierarchy 202. This may be used by the image manager module 116 to identify which images correspond to the request by locating a corresponding file, further discussion of which may be found in relation to FIGS. 3, 4, and 5. Further, the hierarchy may be leveraged to maintain the files and corresponding style sheets. For example, a change may be made to one or more of the images 114. This change may be detected (e.g., via an event) and used by the image manager module 116 to determine which image files 208 and style sheets 210 are affected by the change and therefore are to be regenerated by the image manager module 116. Further discussion of this feature may be found in relation to FIGS. 6 and 7.

Example Implementations

The following discussion describes hierarchical image communication techniques that may be implemented utilizing corresponding systems and devices, as well as other systems and devices. Further, the systems and devices may also be utilized to perform other procedures and arrangements thereof. Aspects of the procedure 300 of FIG. 3 may be implemented in hardware, firmware, or software, or a combination thereof. The procedure 300 is shown as a set of blocks that specify operations performed by one or more devices as illustrated by the corresponding systems 100, 200, 400, 500 of FIGS. 1, 2, 4, and 5, respectively and are not necessarily limited to the orders shown for performing the operations by the respective blocks. Accordingly, the following discussion is arranged as including a description of the system and procedures in parallel.

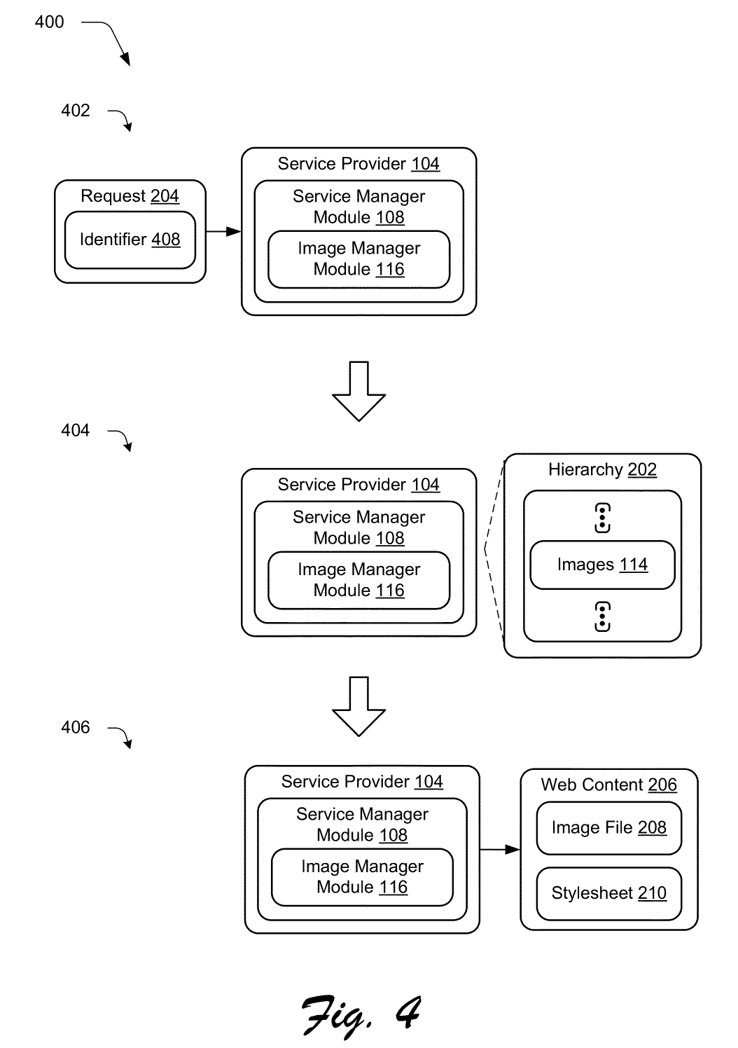

A request is received for web content (block 302). FIG. 4, for instance, illustrates a system 400 through a series of stages that include a first stage 402, a second stage 404, and a third stage 406. At the first stage 402, the request 204 is received by a service provider 104 via the network 106 of FIG. 1. The request 204 may originate from the computing device 102 of FIG. 1 in a variety of ways, such as from a browser, web-enabled application, and so on as previously described. The request 204 includes an identifier 408 that is usable to identify the web content, such as a URL, file name, and so on.

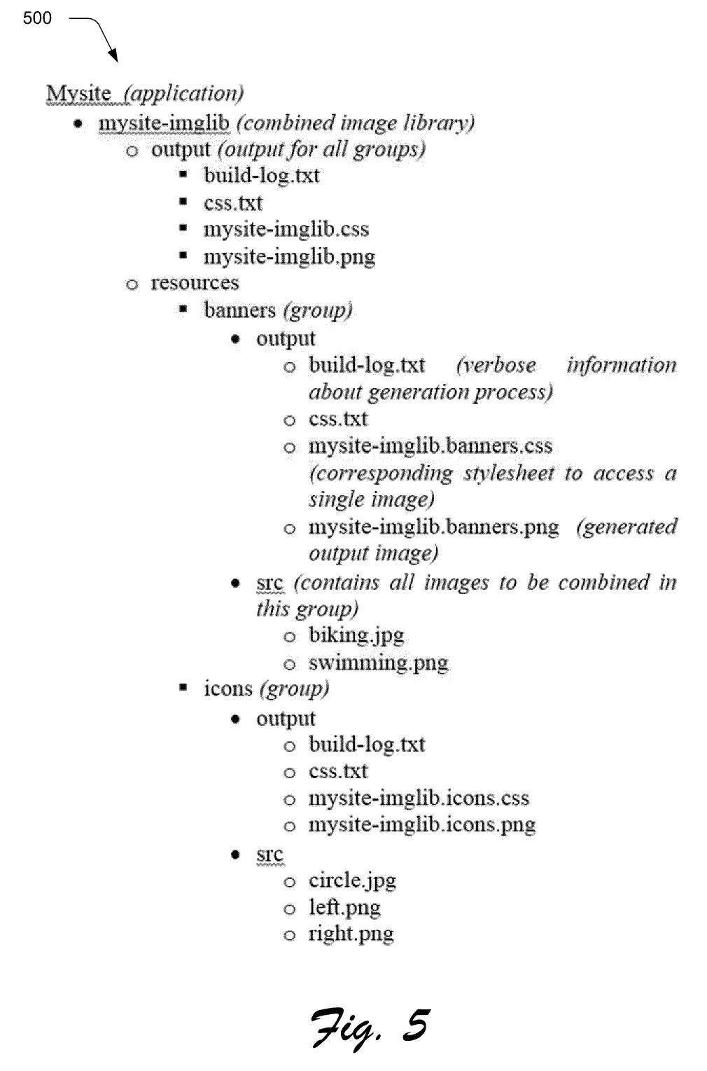

A hierarchical structure is then examined, responsive to the request, to determine which images correspond to the request for the web content (block 304). As shown in the second stage 404 of FIG. 4, the image manager module 116 may examine a hierarchy 202 that includes files having images 114 to determine which images correspond to the request. An example 500 of such a hierarchy is shown in FIG. 5. In this example 500, a hierarchy that corresponds to an application “Mysite” is shown. The application includes two groups, a banners group and an icons group. The banners group includes a text file that includes verbose information about the generation process “build-log.txt,” a single image “mysite-imglib.banners.png” and a corresponding stylesheet “mysite-imaglib.banners.css” that details “where” in the image file individual images may be found. Thus, the banners group is configured as a node that includes a single image file that may include one or more images and a stylesheet that describes “how” to obtain those images.

Likewise, the icons group also includes a text file that includes verbose information about the generation process “build-log.txt,” a single image “mysite-imglib.icons.png” and a corresponding stylesheet “mysite-imaglib.icons.css” that details “where” in the image file individual images may be found. Thus, the icons group is also configured as a node, separate from the banners node, that includes a single image file that may include one or more images and a stylesheet that describes “how” to obtain those images In this way, images of the banners group or the icons group may be identified and obtained individually responsive to the request for the web content.

The example 500 also includes a combined image library as a node that is a parent node to the individual groups (i.e., child nodes) in this example, which is illustrated as “mysite-imglib.” As before, the combined image library includes a text file that includes verbose information about the generation process “build-log.txt,” a single image “mysite-imglib.png” and a corresponding stylesheet “mysite-imaglib.css” that details “where” in the image file individual images may be found. In this example, however, the image file for the parent node includes each of the images included in the child nodes, e.g., the banners and icons groups.

Thus, the hierarchy of nodes may be used to support different requests for content, which may be filled with different individual files of images and corresponding style sheets. For example, a request for the icons or groups may be filled with the respective files, whereas a request that includes both groups (i.e., the application as a whole) may be filled with the combined image library as a single file and corresponding stylesheet.

A communication may then be formed for communication of the web content that includes the files having the plurality of the images as a result of the examining and a stylesheet that is usable to locate individual ones of the plurality of images within the file to generate the requested web content (block 306). As shown in the third stage 406 of FIG. 4, for instance, the web content 206 may include a single image file 208 and stylesheet 210 that is communicated via the network 106 for consumption by the web content consumption module 112 of the computing device 102 of FIG. 1.

Thus, this technique may be utilized to address request queues that may impose a hard limit of parallel operations to a specific domain name. Conventionally, having many raster graphics on a web page can quickly saturate this limit and lead to blocking of loading elements and eventually affect the overall loading performance. Accordingly, raster graphics which do not change dynamically can be combined into a single image file to significantly reduce the number of requests to obtain the web content 110, with the use of style sheets enabling the computing device 102 to selectively display a desired image from the file.

In one or more implementations, the hierarchy 202 is maintained as part of a content repository, e.g. a content repository for Java®, which may include one or more combined image libraries that contain “resource” child nodes. Within this node, the raster graphics may be stored as binaries as part of the file in one or more groups as shown in FIG. 5. This hierarchy 202 may also be used to maintain the images, such as to address changes to one or more of the images 114 as part of the web content 206, further discussion of which may be as follows and shown in the corresponding figures.

The following discussion describes hierarchical image management techniques that may be implemented utilizing corresponding systems and devices, as well as other systems and devices. Further, the systems and devices may also be utilized to perform other procedures and arrangements thereof. Aspects of the procedure 600 of FIG. 6 may be implemented in hardware, firmware, or software, or a combination thereof. The procedure 600 is shown as a set of blocks that specify operations performed by one or more devices as illustrated by the corresponding systems 100, 200, 700 of FIGS. 1, 2, and 7, respectively and are not necessarily limited to the orders shown for performing the operations by the respective blocks. Accordingly, the following discussion is arranged as including a description of the system and procedures in parallel.

A hierarchical structure of images is monitored that includes web content, the hierarchical structure having a plurality of nodes that include files having one or more images and corresponding style sheets describing how to locate the one or more images in the files (block 602). The image manager module 116, for instance, may be configured to listen for changes made to images 114 in the hierarchy 202, may examine the files themselves for changes, be configured to receive events indicating a change that is made to a content repository, and so on.

Responsive to this monitoring, a change is detected in at least one of the images included in a respective one of the nodes (block 604). As shown in the example 700 of FIG. 7, a change 702 may be detected in an image (e.g., “biking.jpg”) that is included in the banner group, e.g., from an event as part of a content repository structure. For instance, each “combined image library” may have a specific primary type and the image manager module 116 may be configured to observe changes to nodes of this particular type, along with corresponding sub-nodes. When a change occurs, the image manager module 116 may thus be informed of the change 702.

Responsive to this detection, one or more files and corresponding style sheets are regenerated that include the changed image (block 606). Continuing with the previous example, the image manager module 116 may identify which nodes (e.g., groups) contain the change, which in this case is the banners group. Accordingly, the image manager module 116 may regenerate this group 704, which may include regeneration of the file containing the images and may also include regeneration of the stylesheet as appropriate.

Additionally, the image manager module 116 may also regenerate one or more files and style sheets of parent nodes, such as to regenerate 706 the file and stylesheet of the combined image library for the “mysite” application. This may be performed in a variety of ways, such as to obtain combine an already cached version of the file and stylesheet for the icons group 708 with a regenerated version of the file and stylesheet for the banners group to form the combined library. A variety of other examples are also contemplated. Thus, the image manager module 116 may combine saved image resources. Furthermore, use of content repositories (e.g., JCR-based applications) and corresponding style sheets may permit usage within a JCR-based application by simply using provided classes of the content repository, e.g., cascading style sheet (CSS) classes.

The hierarchy may be maintained in a variety of ways, such as by using a content management system that may operate as a type of object database to store, search, and retrieve hierarchical content. For example, the hierarchy may be configured to follow a specification in accordance with a content repository API for Java® (JCR) or other dynamic runtime language. The content management system may thus be used to maintain and manage content associated with the hierarchy to manage files and style sheets within the hierarchy and to provide this data as part of web content as described above.

Example System and Device

FIG. 8 illustrates an example system generally at 800 that includes an example computing device 802 that is representative of one or more computing systems and/or devices that may implement the various techniques described herein. This is illustrated through inclusion of the image manager module 116, which may be configured to package web content as described above. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
receiving a request for web content;
examining a hierarchical structure to determine which images correspond to the request for the web content; and
forming a communication for communication of the web content that includes a file having a plurality of the images as a result of the examining and a stylesheet usable to locate individual ones of the plurality of images within the file to generate the requested web content.

2. A method as described in claim 1, wherein the plurality of images are converted from raster graphics included in the web content.

3. A method as described in claim 1, wherein the file is a single file and the plurality of images are configured as sprites that are stored in the single file.

4. A method as described in claim 1, wherein the stylesheet is a cascading stylesheet (CSS).

5. A method as described in claim 1, wherein the hierarchical structure is configured in accordance with a content repository having a plurality of nodes that form the hierarchical structure.

6. A method as described in claim 1, wherein the communication is configured as a content package that is configured for consumption via a content repository application programming interface (API).

7. A method as described in claim 1, wherein the hierarchical structure includes a plurality of groupings and sub-groupings such that images contained in a sub-grouping are also contained in the grouping and the examining is performable to cause the communication to include either the images in the grouping or the images in the subgrouping.

8. A method as described in claim 1, wherein the hierarchical structure includes a plurality of nodes and the examining is performed to locate images from at least two of the plurality of the nodes that are included in the communication.

9. A method implemented by one or more computing devices, the method comprising:
monitoring a hierarchical structure of images for inclusion in web content, the hierarchical structure having a plurality of nodes that include:
files having one or more images; and
corresponding style sheets describing how to locate the one or more images in the files;
responsive to the monitoring, detecting a change in at least one of the images included in a respective one of the nodes; and
responsive to the detecting, regenerating one or more files and corresponding style sheets that include the changed at least one of the images.

10. A method as described in claim 9, wherein:
the hierarchical structure describes a first said node of a grouping of images and a second said node containing a subgrouping of images of the first said node; and
the at least one image is included in the first and second said nodes.

11. A method as described in claim 10, wherein the regenerating of the one or more files and corresponding style sheets is performed for the first and second said nodes.

12. A method as described in claim 9, further comprising caching the regenerated one or more files and corresponding style sheets

13. A method as described in claim 9, further comprising:
examining the hierarchical structure to determine which images correspond to a request for web content; and
forming a communication for communication of the web content that includes the a file having a plurality of the images as a result of the examining and a stylesheet usable to locate individual ones of the plurality of images within the file to generate the requested web content.

14. A method as described in claim 13, wherein the communication is configured as a content package that is configured for consumption via a content repository application programming interface (API).

15. A method as described in claim 9, wherein each of the files include one or more images configured as sprites and the stylesheet is a cascading stylesheet (CSS).

16. A method as described in claim 9, wherein the detecting is performed by receiving an event indicating the change to the hierarchical structure of a content repository.

17. A system comprising:
at least one module implemented at least partially in hardware, the at least one module configured to:
manage a hierarchical structure of images for inclusion in web content, the hierarchical structure having a plurality of nodes that include files having one or more images and corresponding style sheets describing how to locate the one or more images in the files; and
responsive to receipt of an event indicating a change to one or more of the images, regenerating one or more files and corresponding style sheets that include the changed one or more images; and
one or more modules implemented at least partially in hardware, the one or more modules configured to form a communication in response to a request for web content that includes a single file having a plurality of the images and a stylesheet usable to locate individual ones of the plurality of images within the file to generate the requested web content.

18. A system as described in claim 17, wherein:
the at least one module is further configured to cache the regenerated one or more files and corresponding style sheets; and
the communication includes at least one of the cached one or more files and corresponding stylesheet.

19. A system as described in claim 17, wherein the communication is configured as a content package that is configured for consumption via a content repository application programming interface (API).

20. A system as described in claim 17, wherein each of the files include one or more images configured as sprites and the stylesheet is a cascading stylesheet (CSS).
